(19) United States
(12) Patent Application Publication
(10) Pub. No.: US 2021/0284429 A1
(43) Pub. Date: Sep. 16, 2021

(54) CAP MAGAZINE AND CAP MAGAZINE UNIT

(71) Applicant: Lutz Precision, k.s., Bratislava (SK)

(72) Inventor: Marek Matak, Zohor (SK)

(21) Appl. No.: 17/192,812

(22) Filed: Mar. 4, 2021

(30) Foreign Application Priority Data
Mar. 13, 2020 (EP) 20163056.3

(51) Int. Cl. B65D 83/04

(52) U.S. Cl. CPC B65D 83/0409

(57) ABSTRACT

The present disclosure relates to a cap magazine for providing electrode caps at a pick-up position in an output area for picking up by a welding arm, wherein the cap magazine comprises an interior, in which electrode caps can be arranged, and an axle around which the electrode caps, which are adapted to be arranged in the interior, are movable in a direction of rotation around the axle towards the pick-up position. The electrode caps, which are adapted to be arranged in the interior, are preloaded in the direction of rotation around the axle towards the pick-up position. A cap magazine unit comprises two cap magazines.

### CROSS-REFERENCE TO RELATED APPLICATION(S)

This application is based on and claims priority under 35 U.S.C. § 119 to European Patent Application No. 20163056.3 filed on Mar. 13, 2020, in the European Patent Office, the disclosure of which is incorporated by reference herein in its entirety.

### TECHNICAL FIELD

This disclosure relates to a cap magazine.

### BACKGROUND

DE 100 15 768 A1 discloses a device for automatic changing of electrode caps on welding electrode shafts, comprising a cap release device attached to a frame column and a cap magazine. The cap magazine is configured as a drum magazine and is attached to the frame column, the cap magazine including cap accommodating pockets, which are arranged on paths having the shape of circular arcs.

The cap magazine can be adapted to be filled from both sides, so that it will not be necessary to rotate the electrode-bearing tongs for fitting new caps onto an electrode shaft, since one electrode shaft can enter the magazine from one side and the other electrode shaft from the other side.

DE 10 2005 035 915 B3 discloses a spot welding cap changer with a cap extractor and two cap magazines, the cap magazines holding the respective spot-welding caps in a round cap carrier in such a way that they are circularly arranged in a directed and oriented manner and are one by one successively transported by an advancing force against a stop, into an access position.

Each cap magazine contains one cap carrier, which, driven by a spring box, presses a respective one of the caps against the stop with its feed force. The spring box may contain a spiral or a helical spring, the ends of which are fixed to the spring box on one side and to the cap carrier on the other side.

### SUMMARY

Taking as a basis the known prior art, the technical task to be solved is the task of providing a cap magazine and a cap magazine unit, by means of which electrode caps can be made available in a compact manner, the cap magazine and the cap magazine unit being easily loadable with new electrode caps.

According to the present disclosure, this task is solved by the cap magazine of the various embodiments of this disclosure.

The cap magazine according to the present disclosure for providing electrode caps at a pick-up position in an output area for picking up by a welding arm, comprises an interior, in which electrode caps can be arranged, and an axle around which the electrode caps, which are adapted to be arranged in the interior, are movable in a direction of rotation around the axle towards the pick-up position. The electrode caps, which are adapted to be arranged in the interior, are preloaded in the direction of rotation around the axle towards the pick-up position.

The preloaded provision of the electrode caps allows an easy movement of the individual electrode caps from the interior of the cap magazine to the pick-up position in the output area.

The interior may be delimited by a base plate, a lid and an at least partially circular-cylindrical jacket of the cap magazine. Except for the output area of the electrode caps, the jacket may be circular-cylindrical in shape. Towards the output area, it may be open and may e.g. also have a straight shape.

When a rotation in the first direction of rotation takes place and when the electrode caps from the first circle or the second circle are gradually removed from the cap magazine by a welding arm, the pushing device can ensure that no electrode cap will be left behind on the first or second circle, if the forward driving force is no longer transmitted to a sufficient extent, or no longer transmitted at all, by neighboring electrode caps and/or the recesses of the wheel.

The axle may comprise, at a first end thereof, an adapter device, the first end projecting beyond the interior through the lid.

A socket wrench, configured complementarily to the adapter device, may be configured such that it is applicable to the adapter device. The socket wrench may be part of the cap magazine or it may be provided separately from the cap magazine.

The socket wrench applied to the adapter device can be used for linearly moving the axle in a first direction and for thus causing e.g. compression of a compression spring, which surrounds the axle at least partially, for carrying out a rotation of the axle and/or for guiding a linear movement in a second direction opposite to the first direction.

The cap magazine may further comprise a housing, which is arranged outside the interior on the lid and through which the axle may extend, at least partially. The housing may be provided as protection for an axle hole in the lid.

Within the housing, the axle may be surrounded by a compression spring and the axle may comprise a bead, which may circumferentially surround the axle within the housing and on which a first end turn of the compression spring may rest, while a second end turn of the compression spring may rest on the lid.

The compression spring may also be configured as a wave spring or the like.

Through a linear movement of the axle in one direction, so that the bead will be moved towards the lid, caused e.g. by applying to the adapter device a socket wrench configured complementarily to the adapter device and moving the socket wrench in this direction, the bead can compress the compression spring, so that the second end of the axle can be removed from the locking plate. When the second end has been removed from the locking plate, the axle can be rotated in a direction of rotation for retensioning the spiral spring, by way of example. For the purpose of rotating the axle, the socket wrench applied to the adapter device can be used. When the spiral spring has been tensioned, the axle may be moved back linearly so as to reinsert the second end into the locking plate. The compression spring will thus be relieved and the bead will move in a direction away from the lid. The compression spring ensures that the axle can remain at a position at which the second end is accommodated in the locking plate.

A second end of the axle, whose cross-section may be larger than a cross-section of an axle hole of the axle provided in the base plate, may project beyond the base plate, and the base plate may have provided thereon a locking plate with an opening; the second end and the opening may each be configured such that the second end is adapted to be accommodated in the opening in form-fit engagement therewith.

Due to the fact that the cross-section of the second end is larger than the cross-section of the axle hole, the second end is prevented from slipping into the interior of the cap magazine through the axle hole in the base plate.

The second end may be configured as an equilateral triangle, a square, an equilateral pentagon, an equilateral hexagon or the like, and an opening of the locking plate may correspondingly be triangular, square-shaped, pentagonal or hexagonal as well, so that the second end can be accommodated in the opening. For rotating the axle, angles corresponding to a multiple of 120°, 90°, 72° or 60° will then be useful.

The second end may comprise a pin, which may project beyond the second end and which may additionally extend into the axle, or the second end may comprise a cavity, which may extend from the second end into the axle.

The pin and the cavity may be configured such that the part of the pin of a first cap magazine which projects beyond the second end is insertable into the cavity of a second cap magazine.

The cap magazine may comprise a wheel, which is arranged around the axle in the interior and which comprises a plurality of recesses along a circumference of the wheel. The recesses may have a circular segment-like shape and may additionally be configured such that first electrode caps to be provided can be accommodated therein along part of their circumference and can be arranged on a first radius. A circular segment of a recess may have a center angle in a range of 45° to 90°. The cap magazine is, for example, not provided with any holes surrounding the individual electrode caps along their entire circumference in the interior of the cap magazine, and/or is, for example, not provided with any cap accommodation pockets surrounding the individual electrode caps along their entire circumference in the interior of the cap magazine.

A radial distance between the jacket and a center of one of the recesses may be configured such that second electrode caps to be provided can be arranged on a second radius, which is larger than the first radius, such that the second electrode caps to be provided contact, at least partially, the jacket and the first electrode caps to be provided.

This allows a comparatively large number of electrode caps to be arranged in the interior of the cap magazine and to thus make the electrode caps, each individually, available to one or a plurality of welding arms, so that they can be picked up at a pick-up position in the output area. The first electrode caps to be provided can be moved by the recesses to the output area and the second electrode caps to be provided can be moved to the output area by the first electrode caps to be provided and by the boundary defined by the jacket. Hence, it is not necessary that the cap magazine comprises e.g. respective holes surrounding the entire circumference of the individual electrode caps of the electrode caps arranged in the interior, and/or e.g. respective cap accommodation pockets surrounding the entire circumference of the individual electrode caps of the electrode caps arranged in the interior.

A preloadable spiral spring may be provided around the axle, the spiral spring being configured to rotate the wheel in the direction of rotation about the axle, the electrode caps, which are adapted to be arranged in the interior, being thus preloaded in the direction of rotation around the axle towards the pick-up position.

The spiral spring, which is arranged around the axle, may be fastened to the axle at the first point; to this end, a recess may be provided in the axle, into which the spiral spring may be inserted and fixed in position, by way of example. The spiral spring may be fastened to the wheel at a second point.

The cap magazine may further comprise a pushing device, which extends, at least partially, between the wheel and the jacket and which is configured to push, when a rotation in the direction of rotation takes place, the first and second electrode caps to be provided, into the direction of rotation.

The pushing device may comprise a pusher, which has an outer shape corresponding to that of an electrode cap, and a connecting device; the connecting device may connect the pusher with the wheel.

The pusher may be provided on a second circle and connected by means of the connecting device with the wheel side face facing away from the axle. When seen in the first direction of rotation, the pusher and the connecting device may be arranged behind electrode caps located in the interior. In this way, when a rotation in the first direction of rotation takes place and when, guided by the guiding device, the electrode caps are gradually transferred from the first circle or the second circle into the output area and are then removed from the cap magazine by a welding arm, the pusher and the connecting device can ensure that no electrode cap will be left behind on the first or second circle or in the area of the guiding device, if the forward driving force is no longer transmitted to a sufficient extent, or no longer transmitted at all, by neighboring electrode caps and/or the recesses of the wheel.

The lid may comprise an opening in the output area. A welding arm will thus be able to pick up an electrode cap at the pick-up position in the output area.

By providing the opening in the lid of the cap magazine, it will be possible to insert a welding arm, which does not carry an electrode cap, parallel to the axle into an electrode cap arranged in the output area.

The output area may have provided therein a retainer and a downholder for a respective one of the electrode caps.

The electrode cap can be held back in the output area of the cap magazine by the retainer, which may act e.g. by means of a spring force of a restoring spring. The downholder can be used for preventing an electrode cap in the output area from making an undesired upward or downward movement, depending on the orientation of the cap magazine. This has the effect that the electrode cap will remain in the output area until it is picked up by a welding arm and removed from the output area. The downholder may be arranged such that it does not overlap a pick-up area of the welding arm.

The cap magazine may further comprise a guiding device extending from the interior up to and into the output area.

By means of the guiding device, the electrode caps can be guided from the interior into the output area.

The spiral spring may be fastened to the axle and to the wheel.

Due to the fixed position of the axle, the preloaded spiral spring will be able to transmit its spring force to the wheel and to thus rotate the latter.

A cap magazine unit comprises a first and a second cap magazine as described hereinbefore and/or hereinafter, wherein an axle of the first cap magazine and an axle of the second cap magazine are oriented coaxially, wherein an outer surface of a first base plate of the first cap magazine faces an outer surface of a second base plate of the second cap magazine, and wherein a distance is defined between the outer surface of the first base plate and the outer surface of the second base plate.

The distance may be dimensioned such that a respective linear movement of the axles for tensioning the respective spiral spring is possible.

A spacer plate may be provided between the outer surface of the first base plate and the outer surface of the second base plate.

The spacer plate may be configured as a circular ring. The spacer plate may protect an area between the first and the second cap magazine against contamination, the locking plates and the second ends of the axles being located in this area.

The axle of the first cap magazine may be provided with a cavity and the axle of the second cap magazine may be provided with a pin.

During tensioning of the spiral spring of the first cap magazine, the cavity may be put over the pin of the axle of the second cap magazine, so that an orientation along a longitudinal axis of the axle of the first cap magazine can be maintained more precisely when the axle rotates.

During tensioning of the spiral spring of the second cap magazine, the pin may be inserted into the cavity of the axle of the first cap magazine, so that an orientation along a longitudinal axis of the axle of the second cap magazine can be maintained more precisely when the axle rotates

A compression spring, which may partially surround the pin, may be arranged between a second end of the axle of the first cap magazine and a second end of the axle of the second cap magazine. The provision of this single compression spring allows to dispense with the use of the housings on the lids of the cap magazines and the compression springs contained therein.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates a schematic oblique view from above of a first embodiment of a cap magazine unit with two cap magazines according to a first embodiment;

FIG. 2A illustrates a schematic top view of the arrangement according to FIG. 1, with the lid of the upper cap magazine removed and with the cap magazine fully loaded with electrode caps;

FIG. 2B illustrates the arrangement according to FIG. 2A, with part of the electrode caps already removed from the upper cap magazine;

FIG. 3 illustrates a schematic sectional view of the cap magazine unit in a plane parallel to the axles;

FIG. 4 illustrates a top view of the outer surface of the base of the cap magazine;

FIG. 5 illustrates a schematic oblique view from above of a second embodiment of a cap magazine unit with two cap magazines according to a second embodiment;

FIG. 6 illustrates a schematic top view of one of the cap magazines of the second embodiment, with the lid of the cap magazine removed and with only one electrode cap being left in the cap magazine;

FIG. 7 illustrates a schematic sectional view of the cap magazine unit in a plane parallel to the axles;

FIG. 8 illustrates a schematic oblique view from above of a third embodiment of a cap magazine unit with two cap magazines according to a third embodiment; and

FIG. 9 illustrates a schematic sectional view of the cap magazine unit in a plane parallel to the axles.

### DETAILED DESCRIPTION

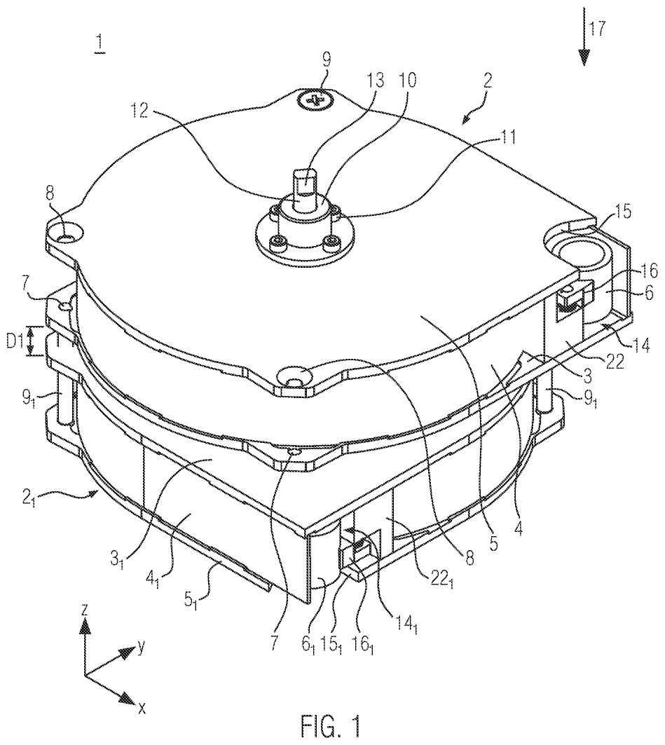

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates a schematic oblique view from above of a first embodiment of a cap magazine unit 1 with an upper cap magazine 2 and a lower cap magazine 21. Since the upper cap magazine 2 and the lower cap magazine 21 can be configured identically, the upper cap magazine 2 will be referred to in the following.

The representation shows a part of a base plate 3, a part of the jacket 4 and the lid 5 of the upper cap magazine 2. The jacket 4 is circular-cylindrical in shape, except for an output area 14 of the electrode caps 6 and encloses an inner area of the cap magazine 2. The base plate 3 and the lid 5 are each provided with through-holes 7, 8 outside the inner area, the through-holes 7, 8 being adapted to receive therein fasteners 9, such as screws, so as to allow the upper cap magazine 2 to be fastened to the lower cap magazine 21 and/or to a holding structure or the like, which is not shown.

The lid 5 has provided thereon, outside the inner area, a housing 10 connected by means of screws 11 to the lid 5. An axle 12 corresponding to a central axis of the circular cylinder, to which the jacket 4 corresponds substantially in shape, projects with a first end beyond the housing 10 and has at this first end an adapter device 13 for a complementarily configured socket wrench, which is adapted for application to the adapter device 13.

In FIG. 1, an electrode cap 6 is arranged, at a pick-up position, in the output area 14 of the electrode caps 6. The lid 5 of the cap magazine 2 has an opening 15 in the output area 14, so that a welding arm without an electrode cap can be inserted from above, i.e. parallel to the axle 12, into the electrode cap 6 arranged at the pick-up position in the output area 14. The electrode cap 6 is held back in the cap magazine 2 by a retainer 16, which acts by means of a spring force of a restoring spring. A downholder, which cannot be seen, prevents the electrode cap 6 at the pick-up position in the output area 14 from making an undesired upward movement. By means of a guiding device 22, which extends from the interior of the cap magazine 2 up to and into the output area 14, the electrode caps 6 are guided one after the other to the pick-up position in the output area 14. The spring force of the retainer 16 is rated such that a welding arm, after it has picked up the electrode cap 6, will be able to remove the electrode cap 6 from the cap magazine 2 by overcoming the spring force when moving perpendicular to the axle 12.

The upper cap magazine 2 faces with an outer surface of its lid 5 in a direction opposite to the direction of action 17 of gravity and with an outer surface of its base plate 3 in the direction of action 17 of gravity. The lid 5 and the base are each oriented perpendicular to the direction of action 17 of gravity.

The lower cap magazine 2₁ is oriented with respect to the upper cap magazine 2 such that an outer surface of the base plate 3₁ of the lower cap magazine 2₁ faces in a direction opposite to the direction of action 17 of gravity and that its base plate 3₁ extends parallel to a base plate 3 of the upper cap magazine 2.

The two output areas 14, 14₁ are arranged on one side of the cap magazine unit 1. A virtual extension of an axle 12 of the upper cap magazine 2, which will be described in more detail hereinafter, and a virtual extension of an axle of the lower cap magazine 2₁, which axle cannot be seen in FIG. 1, are arranged such that they merge with one another; the two axles are oriented coaxially.

Between the outer surface of the base plate 3₁ of the lower cap magazine 2₁ and the outer surface of the base plate 3 of the upper cap magazine 2 a distance D1 is formed.

It follows that the two cap magazines 2, 2₁ are oriented such that an electrode cap 6, 6₁ picked up by a welding arm can be removed from both cap magazines 2, 2₁ during a movement parallel to the x-axis out of the respective cap magazine 2, 2₁.

In view of the fact that the base plate 3₁ of the lower cap magazine 2₁ faces upwards, the downholder, which cannot be seen, prevents an electrode cap 6₁ at the pick-up position from dropping out of the output area 14₁, i.e. from making an undesirable downward movement.

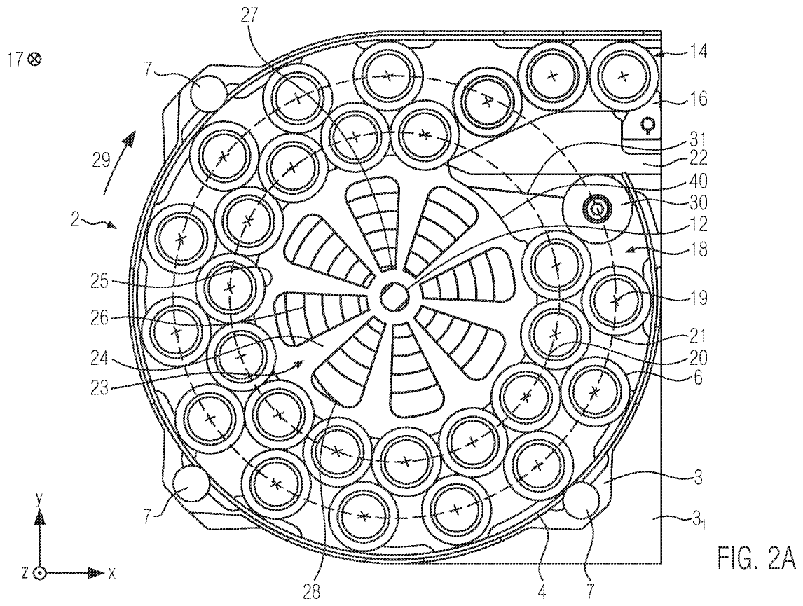

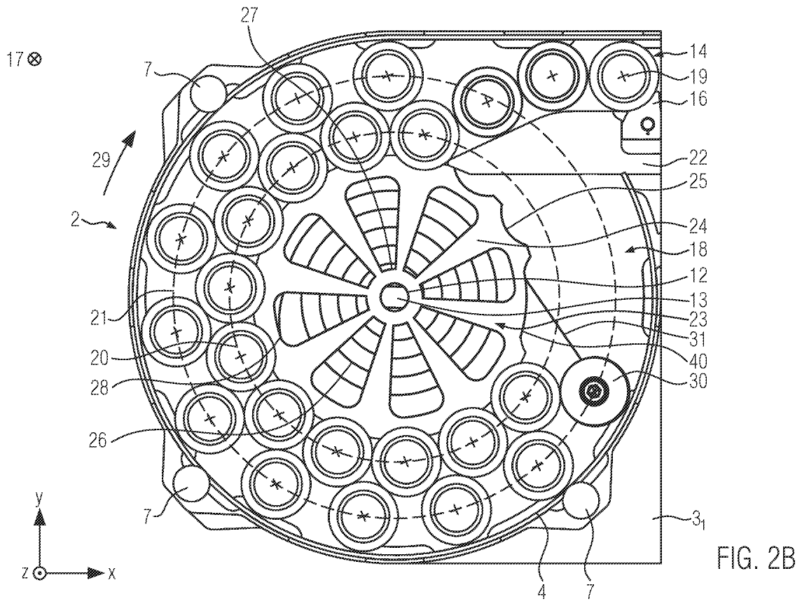

FIG. 2A illustrates a top view of the arrangement according to FIG. 1, with the lid of the upper cap magazine 2 removed and an interior 18 of the cap magazine 2 visible, the cap magazine 2 being loaded with 28 electrode caps 6 in two rows.

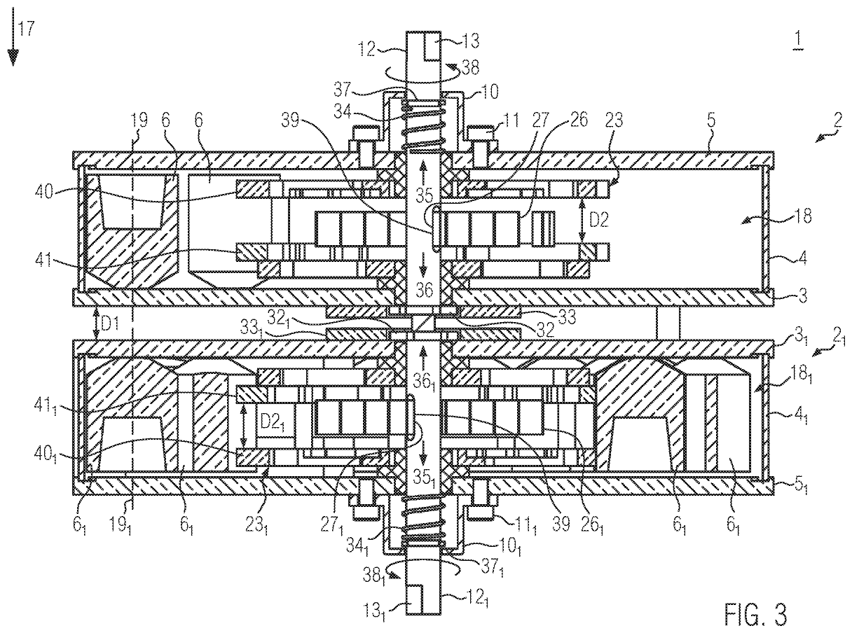

In the interior 18, the axle 12 is surrounded by a wheel 23 comprising an upper part 40, which can be seen here, and a lower part, which cannot be seen here, (cf. e.g. FIG. 3) with eight spokes 24 each. The respective side faces of the upper part 40 and of the lower part of the wheel 23, which face away from the axle 12, each comprise thirteen recesses 25 in the form of circular segments along a partial circumference. The recesses 25 are configured such that electrode caps 6 can be accommodated therein along part of their circumference, and when the electrode caps 6 have been accommodated therein along part of their circumference, they can contact, on a first circle 20, one (for the two electrode caps 6 at both ends of the partial circumference) or both (for the other eleven electrode caps 6) adjacent electrode caps 6 at a point of their respective circumference. The first circle 20 extends through the central axes of the electrode caps 6, which are arranged in the recesses 25, and has a first radius R1.

Between the jacket 4 of the cap magazine and the electrode caps 6 on the first circle 20, thirteen additional electrode caps 6 are arranged on a second circle 21. The second circle 21 extends through the central axes of these thirteen electrode caps 6 and has a second radius R2. The electrode caps 6 on the second circle 21 contact two respective ones of the electrode caps 6 arranged on the first circle at a point of their respective circumference and the jacket 4 in the interior 18 at one point each. The electrode caps 6 on the first circle 20 can thus be moved forward by means of the recesses 25 when the wheel 23 rotates about the axle 12 in a first direction of rotation 29 (here clockwise), and the electrode caps 6 on the second circle 21 will thus be moved forward as well.

Rotation of the wheel 23 in the first direction of rotation 29 is achieved by a preloaded spiral spring 26, which surrounds the axle 12 and which is fastened to the axle 12 at a first point 27 and to the wheel 23 at a second point. When an electrode cap 6 at the pick-up position is removed from the output area 14, the wheel 23 will be moved by the spring force in the first direction of rotation 29 and a new electrode cap 6 can be moved to the pick-up position in the output area 14. In the course of this process, the electrode caps 6 are guided from the first circle 20 or the second circle 21 into the output area 14 by the guiding device 22.

The second circle 21 has additionally provided thereon a pusher 30 whose outer shape corresponds to that of an electrode cap, the pusher 30 being connected by a connecting device 31 to the wheel side face facing away from the axle 12. When seen in the first direction of rotation 29, the pusher 30 and the connecting device 31 are arranged behind the electrode caps 6 located in the interior 18. In this way, when a rotation in the first direction of rotation 29 takes place and when, guided by the guiding device 22, the electrode caps 6 are gradually transferred from the first circle 20 or the second circle 21 into the output area 14 and are then removed from the cap magazine by a welding arm, the pusher 30 and the connecting device 31 can ensure that no electrode cap will be left behind on the first or second circle 20, 21 or in the area of the guiding device 22, if the forward driving force is no longer transmitted to a sufficient extent, or no longer transmitted at all, by neighboring electrode caps 6 and/or the recesses 25 of the wheel 23.

FIG. 2B illustrates the arrangement of FIG. 2A, with part of the electrode caps 6 already removed from the upper cap magazine 2, 24 electrode caps 6 are still contained in the upper cap magazine 2. The pusher 30 together with the recesses 25 and the spiral spring 26 ensure that the electrode caps 6 are pushed forward in the first direction 29.

FIG. 3 illustrates a schematic sectional view of the cap magazine unit 1 in a plane parallel to the axles 12, 12₁. The visible part of the upper/lower cap magazines 2, 2₁ is thus the interior 18, 18₁, which is delimited by the base plate 3, 3₁, the jacket 4, 4₁ and the lid 5, 5₁ and in which a plurality of electrode caps 6, 6₁ is arranged.

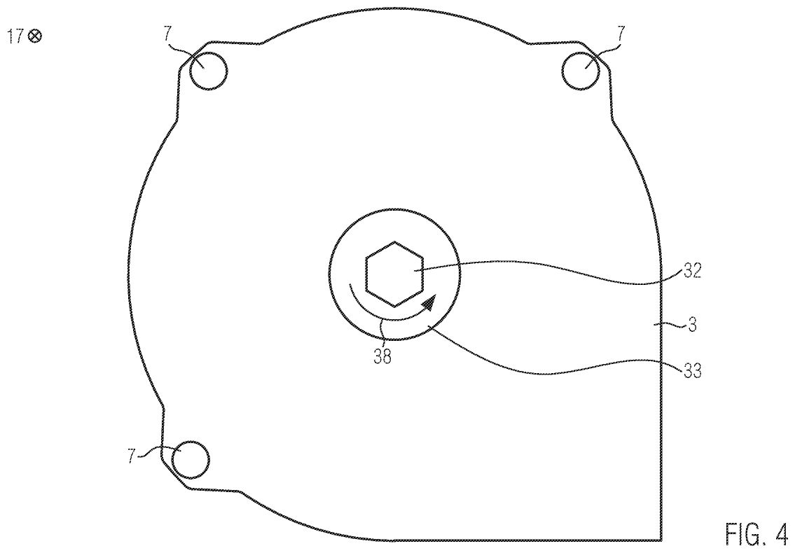

The axle 12, 12₁ projects beyond the housing 10, 10₁ with its first end comprising the adapter device 13, 13₁. The second end 32, 32₁ of the axle 12, 12₁ projects beyond the base plate 3, 3₁ and is dimensioned such that it cannot slip through the axle hole provided in the base plate 3, 3₁ into the interior 18, 18₁ of the cap magazine 2, 2₁. The outer surface of the base plate 3, 3₁ has arranged thereon a locking plate 33, 33₁ provided with an opening into which the second end 32, 32₁ can be inserted (cf. also FIG. 4).

The housing 10, 10₁, which is secured to the outer surface of the lid 5, 5₁ by means of screws 11, 11₁, has arranged therein a compression spring 34, 34₁, which surrounds the axle 12, 12₁. The compression spring 34, 34₁ may also be configured as a wave spring or the like. One end turn of the compression spring 34, 34₁ rests on the outer surface of the lid 5, 5₁ and the other end turn of the compression spring 34, 34₁ rests on a bead 37, 37₁, which surrounds the axle 12, 12₁ within the housing 10, 10₁ circumferentially. Through a movement of the axle 12, 12₁ in the second direction 36, 36₁, caused e.g. by applying to the adapter device 13, 13₁ a socket wrench configured complementarily to the adapter device 13, 13₁ and moving the socket wrench in the second direction 36, 36₁, the bead 37, 37₁ can compress the compression spring 34, 34₁, so that the second end 32, 32₁ can be removed from the locking plate 33, 33₁. In this way, the axle 12, 12₁ can be rotated in a second direction of rotation 38, 38₁ so as to retension the spiral spring 26, 26₁, by way of example. When the spiral spring 26, 26₁ has been tensioned, the axle 12, 12₁ can be moved in the first direction 35, 35₁, so as to be able to reinsert the second end 32, 32₁ into the locking plate 33, 33₁. The second end 32, 32₁ may here be configured as an equilateral hexagon and an opening of the locking plate 33, 33₁ may be hexagonal as well, so that the second end 32, 32₁ can be accommodated in the opening. For rotating the axle 12, 12₁, angles corresponding to a multiple of 60° will then be useful. However, the second end may also be configured as an equilateral triangle, a square, an equilateral pentagon or the like, the opening of the locking plate being then configured accordingly. For rotating the axle, angles corresponding to a multiple of 120°, 90° or 72° will then be useful.

The spiral spring 26, 26₁ arranged around the axle 12, 12₁ is fastened to the axle 12, 12₁ at the first point 27, 27₁; for this purpose, a recess 39, 39₁ is provided in the axle 12, 12₁, into which the spiral spring 26, 26₁ can be inserted and fixed in position, by way of example. The spiral spring 26, 26₁ is arranged in an area between the upper part 40, 40₁ and the lower part 41, 41₁ of the wheel 23, 23₁, a distance D2 between the upper part 40, 40₁ and the lower part 41, 41₁ being dimensioned such that the spiral spring 26, 26₁ fits therebetween and also a movement in the second direction 36, 36₁, which is caused by a corresponding movement of the axle 12, 12₁ in the second direction 36, 361, is possible.

FIG. 4 illustrates a top view of the second end 32 of axle 12, which projects beyond the base plate 3. The second end 32 is here exemplarily hexagonal in shape, the dimension being of such a nature that the second end 32 cannot slip through the axle hole provided in the base plate 3 into the interior 18 of the cap magazine 2. The outer surface of the base plate 3 has arranged thereon a locking plate 33 provided with a hexagonal opening into which the hexagonal second end 32 of the axle 12 can be inserted in a form-fit manner and retained therein. As has already been described with respect to FIG. 3, the bead 37, 37₁ of the axle 12, 12₁ can compress the compression spring 34, 34₁ through a movement of the axle 12, 12₁ in the second direction 36, 36₁, so that the second end 32, 32₁ can be removed from the locking plate 33, 33₁. In this way, the axle 12, 12₁ can be rotated in a second direction of rotation 38, 38₁ so as to retension the spiral spring 26, 26₁, by way of example. When the spiral spring 26, 26₁ has been tensioned, the axle 12, 12₁ can be moved in the first direction 35, 35₁, so as to be able to reinsert the second end 32, 32₁ into the locking plate 33, 33₁. The angle of rotation of the axle 12, 12₁ is here preferably a multiple of 60°.

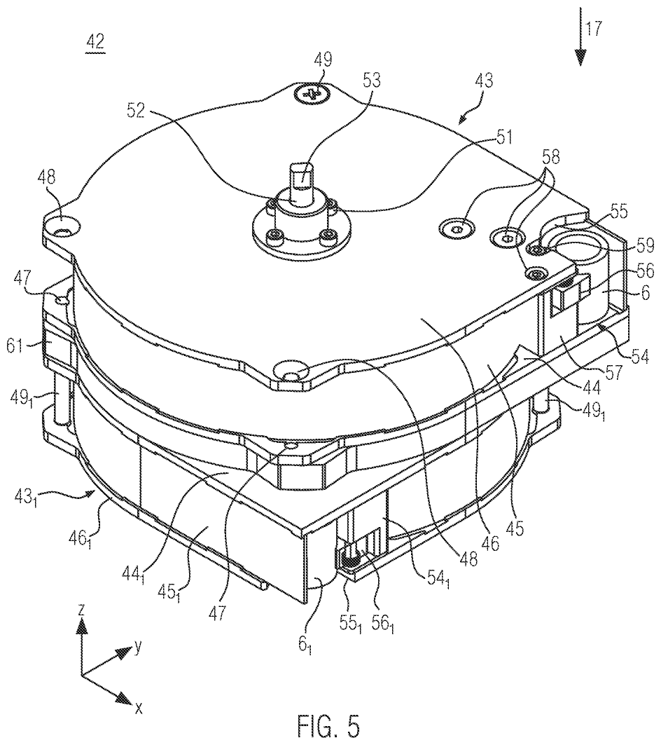

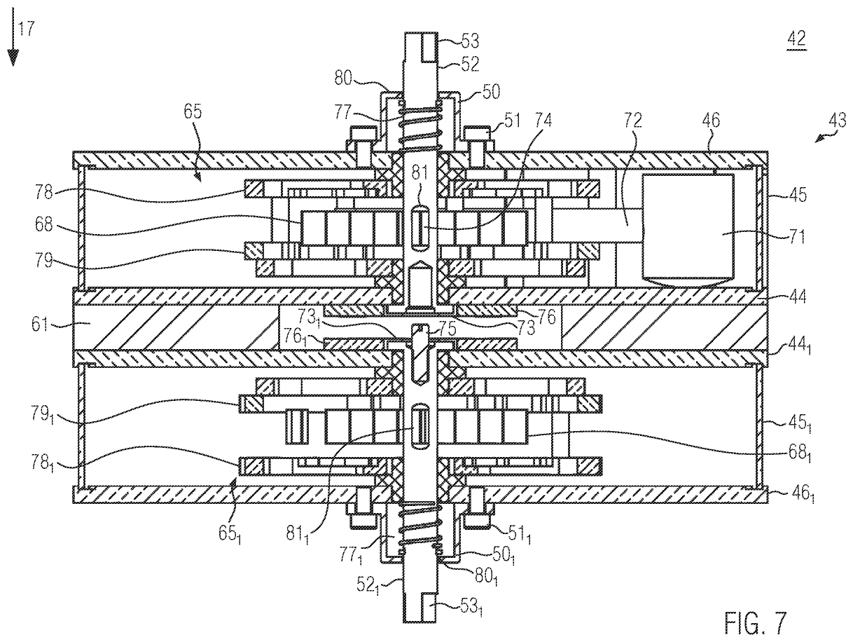

FIG. 5 illustrates a schematic oblique view from above of a second embodiment of a cap magazine unit 42 with an upper cap magazine 43 and a lower cap magazine 43₁. Since the upper cap magazine 43 and the lower cap magazine 43₁ can be configured identically, except for the axles 52, 52₁, the upper cap magazine 43 will be referred to in the following. The differences between the axles 52, 52₁ will be explained in more detail in FIG. 7.

In the representation, part of a base plate 44, part of the jacket 45 and the lid 46 of the upper cap magazine 43 can be seen. The jacket 45 is circular-cylindrical in shape, except for an output area 54 of the electrode caps 6, and encloses an inner area of the cap magazine 43. The base plate 44 and the lid 46 are each provided with through-holes 47, 48 outside the inner area, the through-holes 47, 48 being adapted to receive therein fasteners 49, such as screws, so as to allow the upper cap magazine 43 to be fastened to the lower cap magazine 43₁ and/or to a holding structure or the like, which is not shown.

The lid 46 has provided thereon, outside the inner area, a housing 50 connected by means of screws 51 to the lid 46. An axle 52 corresponding to a central axis of the circular cylinder, to which the jacket 45 corresponds substantially in shape, projects with a first end beyond the housing 50 and has at this first end an adapter device 53 for a complementarily configured socket wrench, which is adapted for application to the adapter device 53.

In FIG. 5, an electrode cap 6 is arranged, at a pick-up position, in the output area 54 of the electrode caps 6. The lid 46 of the cap magazine 43 has an opening 55 in the output area 54, so that a welding arm without an electrode cap can be inserted from above, i.e. parallel to the axle 52, into the electrode cap 6 arranged at the pick-up position in the output area 54. The electrode cap 6 is held back in the cap magazine 43 by a retainer 56, which acts by means of a spring force of a restoring spring. A downholder, which cannot be seen, but the fastening screw 59 of which can be seen, prevents the electrode cap 6 at the pick-up position in the output area 54 from making an undesired upward movement. By means of a guiding device 57, which extends from an interior of the cap magazine 43 up to and into the output area 54 and which is fastened by means of screws 58 to the lid 46, the electrode caps 6 are guided into the output area 54. The spring force of the retainer 56 is rated such that a welding arm, after it has picked up the electrode cap 6, will be able to remove the electrode cap 6 from the cap magazine 43 by overcoming the spring force when moving perpendicular to the axle 52 in an x-direction.

The upper cap magazine 43 faces with an outer surface of its lid 46 in a direction opposite to the direction of action 17 of gravity and with an outer surface of its base plate 44 in the direction of action 17 of gravity. The lid 46 and the base plate 44 are each oriented perpendicular to the direction of action 17 of gravity.

The lower cap magazine 43₁ is oriented with respect to the upper cap magazine 43 such that an outer surface of the base plate 44₁ of the lower cap magazine 43₁ faces in a direction opposite to the direction of action 17 of gravity and that its base plate 44₁ extends parallel to the base plate 44 of the upper cap magazine 43.

The two output areas 54, 54₁ are arranged on one side of the cap magazine unit 42. A virtual extension of an axle 52 of the upper cap magazine 43, which will be described in more detail hereinafter, and a virtual extension of an axle of the lower cap magazine 43₁, which axle cannot be seen in FIG. 5, are arranged such that they merge with one another; the two axles are oriented coaxially.

Between the outer surface of the base plate 44₁ of the lower cap magazine 43₁ and the outer surface of the base plate 44 of the upper cap magazine 43 a spacer plate 61 is arranged.

It follows that the two cap magazines 43, 43₁ are oriented such that an electrode cap 6, 6₁ picked up by a welding arm can be removed from both cap magazines 43, 43₁ during a movement parallel to the x-axis out of the respective cap magazine 43, 43₁.

In view of the fact that the base plate 44₁ of the lower cap magazine 43₁ faces upwards, the downholder, which cannot be seen, prevents an electrode cap 6₁ at the pick-up position from dropping out of the output area 54, i.e. from making an undesirable downward movement.

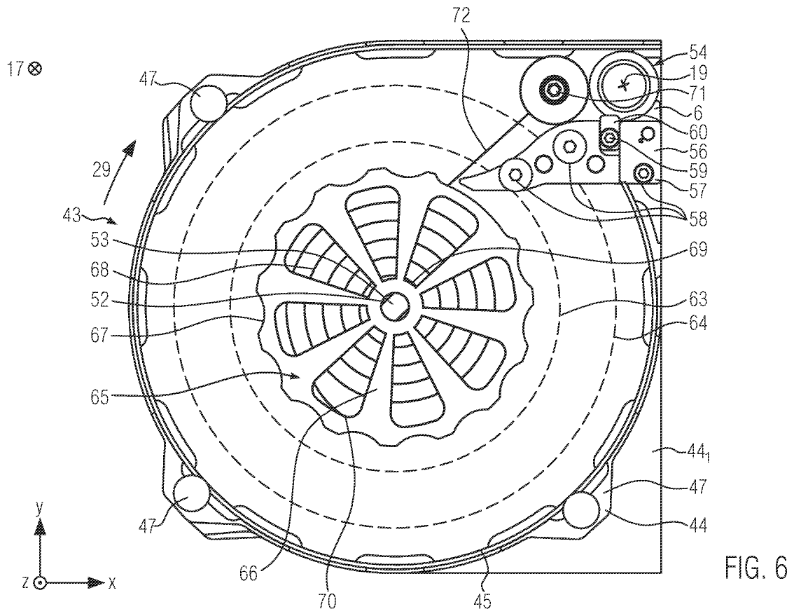

FIG. 6 illustrates a schematic top view of the arrangement according to FIG. 5, with the lid of the upper cap magazine 43 removed and an interior 62 of the cap magazine 43 visible, the cap magazine 43 being adapted to be loaded with two rows of electrode caps like the cap magazine 2 of the first embodiment.

In the interior 62, the axle 52 is surrounded by a wheel 65 comprising an upper part 78, which can be seen here, and a lower part, which cannot be seen here, (cf. FIG. 7) with eight spokes 66 each. The respective side faces of the upper part 78 and of the lower part of the wheel 65, which face away from the axle 52, each comprise thirteen recesses 67 in the form of circular segments along a partial circumference. The recesses 67 are configured such that electrode caps can be accommodated therein along part of their circumference, and when the electrode caps have been accommodated therein along part of their circumference, they can contact, on a first circle 63, one (for the two electrode caps at both ends of the partial circumference) or both (for the other electrode caps) neighboring electrode caps at a point of their respective circumference. The first circle 63 extends through the central axes of the electrode caps, which can be arranged in the recesses 67, and has a first radius R1.

Between the jacket 45 of the cap magazine 43 and the electrode caps on the first circle 63, additional electrode caps may be arranged on a second circle 64. The second circle 64 extends through the central axes of these electrode caps and has a second radius R2. Electrode caps on the second circle 64 may contact two respective ones of the electrode caps arranged on the first circle 63 at a point of their respective circumference and the jacket 45 in the interior 62 at one point each. The electrode caps on the first circle 63 can thus be moved forward by means of the recesses 67 when the wheel 65 rotates about the axle 52 in a first direction of rotation 29 (here clockwise), and the electrode caps on the second circle 64 are thus moved forward as well.

Rotation of the wheel 65 in the first direction of rotation 29 is achieved by a preloaded spiral spring 68, which surrounds the axle 52 and which is fastened to the axle 52 at a first point 69 and to the wheel 65 at a second point 70. When an electrode cap 6 at the pick-up position is removed from the output area 54, the wheel 65 will be moved by the spring force in the first direction of rotation 29 and a new electrode cap 6 can be moved to the pick-up position in the output area 54. In the course of this process, the electrode caps are guided from the first circle 63 or the second circle 64 into the output area 54 by the guiding device 57.

The second circle 64 has additionally provided thereon a pusher 71 whose outer shape corresponds to that of an electrode cap, the pusher 71 being connected by a connecting device 72 to the wheel side face facing away from the axle 52. When seen in the first direction of rotation 29, the pusher 71 and the connecting device 72 are arranged behind the electrode caps located in the interior 62. In this way, when a rotation in the first direction of rotation 29 takes place and when, guided by the guiding device 57, the electrode caps are gradually transferred from the first circle 63 or the second circle 64 into the output area 54 and are then removed from the cap magazine by a welding arm, the pusher 71 and the connecting device 72 can ensure that no electrode cap will be left behind on the first or second circle 63, 64 or in the area of the guiding device 57, if the forward driving force is no longer transmitted to a sufficient extent, or no longer transmitted at all, by neighboring electrode caps and/or the recesses 67 of the wheel 65.

FIG. 7 illustrates a schematic sectional view of the cap magazine unit 42 in a plane parallel to the axles 52, 52₁. The visible part of the upper/lower cap magazines 43, 43₁ is thus the interior 62, 62₁, which is delimited by the base plate 44, 44₁, the jacket 45, 45₁ and the lid 46, 46₁.

The two axles 52, 52₁ project beyond the housing 50, 50₁ with the first end comprising the adapter device 53, 53₁.

The second end 73 of the axle 52 of the upper cap magazine 43 projects beyond the base plate 44 and is dimensioned such that it cannot slip through the axle hole provided in the base plate 44 into the interior 62 of the cap magazine 43. The outer surface of the base plate 44 has arranged thereon a locking plate 76 provided with an opening into which the second end 73 can be inserted. In addition, the axle 52 comprises a cavity 74, which extends from the second end 73 into the axle 52.

Also the second end 73₁ of the axle 52₁ of the lower cap magazine 43₁ projects beyond the base plate 44₁ and is dimensioned such that it cannot slip through the axle hole provided in the base plate 44₁ into the interior 62₁ of the cap magazine 43₁. The outer surface of the base plate 44₁ has arranged thereon a locking plate 76₁ provided with an opening into which the second end 73₁ can be inserted. In addition, the axle 52₁ comprises a pin 75, which projects beyond the second end 73₁ and extends into the axle 52₁.

The pin 75 and the cavity 74 are configured such that the part of the pin 75 projecting beyond the second end 73₁ is adapted to be inserted into the cavity 74.

The housing 50, 50₁, which is secured by means of screws 51, 51₁ to the outer surface of the lid 46, 46₁, has arranged therein a compression spring 77, 77₁, which surrounds the axle 52, 52₁. The compression spring 77, 77₁ may also be configured as a wave spring or the like. One end turn of the compression spring 77, 77₁ rests on the outer surface of the lid 46, 46₁ and the other end turn of the compression spring 77, 77₁ rests on a bead 80, 80₁, which surrounds the axle 52, 52₁ within the housing 50, 50₁ circumferentially. Through a movement of the axle 52, 52₁ in the second direction 36, 36₁, caused e.g. by applying to the adapter device 53, 53₁ a socket wrench configured complementarily to the adapter device 53, 53₁ and moving the socket wrench in the second direction 36, 36₁, the bead 80, 80₁ can compress the compression spring 77, 77₁, so that the second end 73, 73₁ can be removed from the locking plate 76, 76₁. In this way, the axle 52, 52₁ can be rotated in a second direction of rotation 38, 38₁ so as to retension the spiral spring 68, 68₁, by way of example. When the spiral spring 68, 68₁ has been tensioned, the axle 52, 52₁ can be moved in the first direction 35, 35₁, so as to be able to reinsert the second end 73, 73₁ into the locking plate 76, 76₁. The second end 73, 73₁ may here be configured as an equilateral triangle, a square, an equilateral pentagon, an equilateral hexagon or the like and an opening of the locking plate 76, 76₁ may be triangular, square-shaped, pentagonal or hexagonal as well, so that the second end 73, 73₁ can be accommodated in the opening. For rotating the axle 52, 52₁ angles corresponding to a multiple of 120°, 90°, 72° or 60° will then be useful.

The spiral spring 68, 68₁ arranged around the axle 52, 52₁ is fastened to the axle 52, 52₁ at the first point 69, 69₁; for this purpose, a recess 81, 81₁ is provided in the axle 52, 52₁, into which the spiral spring 68, 68₁ can be inserted and fixed in position, by way of example. The spiral spring 68, 68₁ is arranged in an area between the upper part 78, 78₁ and the lower part 79, 79₁ of the wheel 65, 65₁, a distance D3 between the upper part 78, 78₁ and the lower part 79, 79₁ being dimensioned such that the spiral spring 68, 68₁ fits therebetween and also a movement in the second direction 36, 36₁, which is caused by a corresponding movement of the axle 52, 52₁ in the second direction 36, 36₁, is possible.

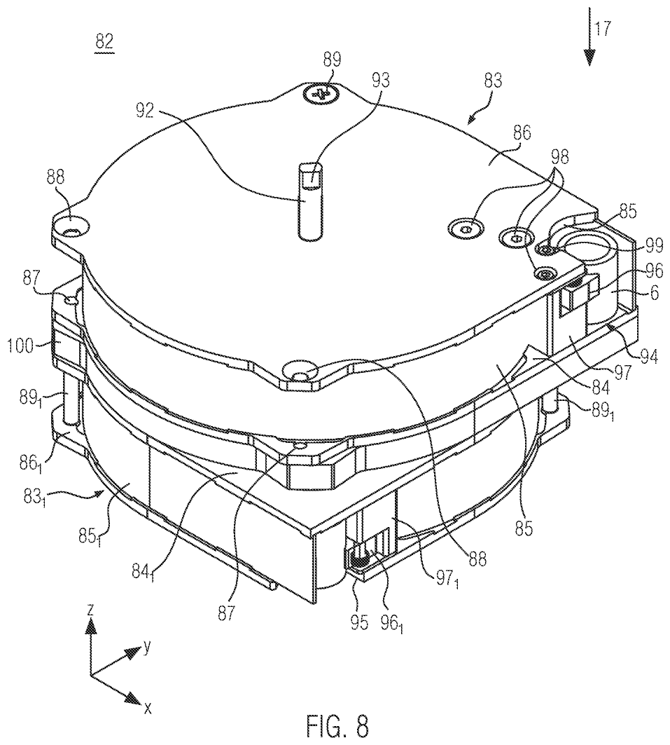

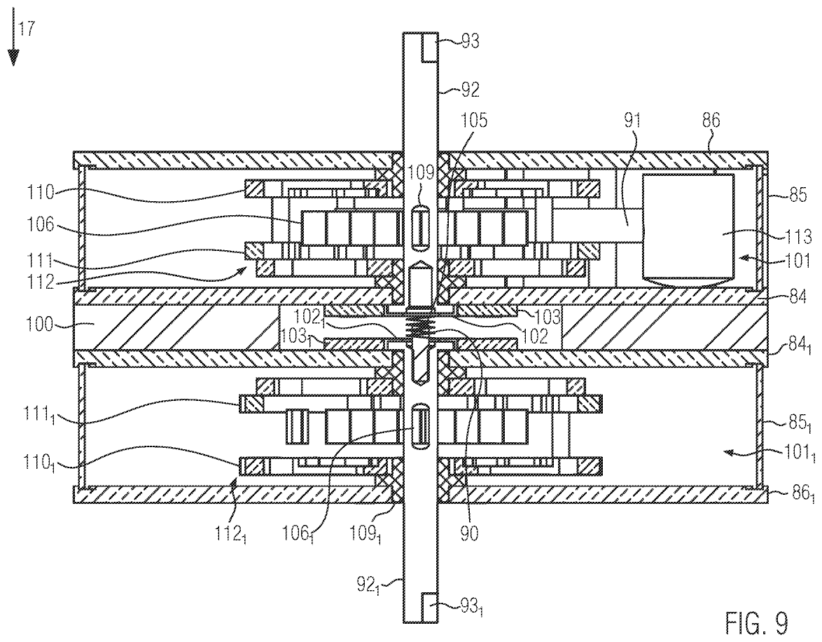

FIG. 8 illustrates a schematic oblique view from above of a third embodiment of a cap magazine unit 82 with an upper cap magazine 83 and a lower cap magazine 83₁. Since the upper cap magazine 83 and the lower cap magazine 83₁ can be configured identically, except for the axles 92, 92₁, the upper cap magazine 83 will be referred to in the following. The differences between the axles 92, 92₁ will be explained in more detail in FIG. 9.

In the representation, part of a base plate 84, part of the jacket 85 and the lid 86 of the upper cap magazine 83 can be seen. The jacket 85 is circular-cylindrical in shape, except for an output area 94 of the electrode caps 6, and encloses an inner area of the cap magazine 83. The base plate 84 and the lid 86 are each provided with through-holes 87, 88 outside the inner area, the through-holes 87, 88 being adapted to receive therein fasteners 89, such as screws, so as to allow the upper cap magazine 83 to be fastened to the lower cap magazine 83₁ and/or to a holding structure or the like, which is not shown.

The axle 92 corresponding to a central axis of the circular cylinder, to which the jacket 85 corresponds substantially in shape, projects with a first end beyond the lid 86 and has at this first end an adapter device 93 for a complementarily configured socket wrench, which is adapted for application to the adapter device 93.

In FIG. 8, an electrode cap 6 is arranged, at a pick-up position, in the output area 94 of the electrode caps 6. The lid 86 of the cap magazine 83 has an opening 95 in the output area 94, so that a welding arm without an electrode cap can be inserted from above, i.e. parallel to the axle 92, into the electrode cap 6 arranged at the pick-up position in the output area 94. The electrode cap 6 is held back in the cap magazine 83 by a retainer 96, which acts by means of a spring force of a restoring spring. A downholder, which cannot be seen, but the fastening screw 99 of which can be seen, prevents the electrode cap 6 at the pick-up position in the output area 94 from making an undesired upward movement. By means of a guiding device 97, which extends from the interior of the cap magazine 83 up to and into the output area 94 and which is fastened by means of screws 98 to the lid 86, the electrode caps 6 are guided into the output area 94. The spring force of the retainer 96 is rated such that a welding arm, after it has picked up the electrode cap 6, will be able to remove the electrode cap 6 from the cap magazine 83 by overcoming the spring force when moving perpendicular to the axle 92 in an x-direction.

The upper cap magazine 43 faces with an outer surface of its lid 86 in a direction opposite to a direction of action 17 of gravity and with an outer surface of its base plate 84 in the direction of action 17 of gravity. The lid 86 and the base plate 84 are each oriented perpendicular to the direction of action 17 of gravity.

The lower cap magazine 83₁ is oriented with respect to the upper cap magazine 83 such that an outer surface of the base plate 84₁ of the lower cap magazine 83₁ faces in a direction opposite to the direction of action 17 of gravity and that its base plate 84₁ extends parallel to the base plate 84 of the upper cap magazine 83.

The two output areas 94, 94₁ are arranged on one side of the cap magazine unit 82. A virtual extension of an axle 92 of the upper cap magazine 83, which will be described in more detail hereinafter, and a virtual extension of an axle of the lower cap magazine 83₁, which axle cannot be seen in FIG. 8, are arranged such that they merge with one another; the two axles are oriented coaxially.

Between the outer surface of the base plate 84₁ of the lower cap magazine 83₁ and the outer surface of the base plate 84 of the upper cap magazine 83 a spacer plate 100 is arranged.

It follows that the two cap magazines 83, 83₁ are oriented such that an electrode cap 6, 6₁ picked up by a welding arm can be removed from both cap magazines 83, 83₁ during a movement parallel to the x-axis out of the respective cap magazine 83, 83₁.

In view of the fact that the base plate 84₁ of the lower cap magazine 83₁ faces upwards, the downholder, which cannot be seen, prevents an electrode cap 6₁ at the pick-up position from dropping out of the output area 94, i.e. from making an undesirable downward movement.

FIG. 9 illustrates a schematic sectional view of the cap magazine unit 82 in a plane parallel to the axles 92, 92₁. The visible part of the upper/lower cap magazines 83, 83₁ is thus the interior 101, 101₁, which is delimited by the base plate 84, 84₁, the jacket 85, 85₁ and the lid 86, 86₁.

The two axles 92, 92₁ project beyond the respective lid 86, 86₁ with the first end comprising the adapter device 93, 93₁.

The second end 102 of the axle 92 of the upper cap magazine 83 projects beyond the base plate 84 and is dimensioned such that it cannot slip through the axle hole provided in the base plate 84 into the interior 101 of the cap magazine 83. The outer surface of the base plate 84 has arranged thereon a locking plate 103 provided with an opening into which the second end 102 can be inserted. In addition, the axle 92 comprises a cavity 104, which extends from the second end 102 into the axle 92.

Also the second end 102₁ of the axle 92₁ of the lower cap magazine 83₁ projects beyond the base plate 84₁ and is dimensioned such that it cannot slip through the axle hole provided in the base plate 84₁ into the interior 101₁ of the cap magazine 83₁. The outer surface of the base plate 84₁ has arranged thereon a locking plate 103₁ provided with an opening into which the second end 102₁ can be inserted. In addition, the axle 92₁ comprises a pin 105, which projects beyond the second end 102₁ and extends into the axle 92₁.

The pin 105 and the cavity 104 are configured such that the part of the pin 105 projecting beyond the second end 102₁ is adapted to be inserted into the cavity 104.

Between the two second ends 102, 102₁, a compression spring 90 is arranged. The compression spring 90 may also be configured as a wave spring or the like. Through a movement of the axle 92, 92₁ in the second direction 36, 36₁, caused e.g. by applying to the adapter device 93, 93₁ a socket wrench configured complementarily to the adapter device 93, 93₁ and moving the socket wrench in the second direction 36, 36₁, the compression spring can be compressed, so that the second end 102, 102₁ can be removed from the locking plate 103, 103₁. In this way, the axle 92, 92₁ can be rotated in a second direction of rotation 38, 38₁ so as to retension the spiral spring 106, 106₁, by way of example. When the spiral spring 106, 106₁ has been tensioned, the axle 92, 92₁ can be moved in the first direction 35, 35₁, so as to be able to reinsert the second end 102, 102₁ into the locking plate 103, 103₁. The second end 102, 102₁ may here be configured as an equilateral triangle, a square, an equilateral pentagon, an equilateral hexagon or the like and an opening of the locking plate 103, 103₁ may be triangular, square-shaped, pentagonal or hexagonal as well, so that the second end 102, 102₁ can be accommodated in the opening. For rotating the axle 92, 92₁ angles corresponding to a multiple of 120°, 90°, 72° or 60° will then be useful.

The spiral spring 106, 106₁ arranged around the axle 92, 92₁ is fastened to the axle 92, 92₁ at the first point 107, 107₁; for this purpose, a recess 109, 109₁ is provided in the axle 92, 92₁, into which the spiral spring 106, 106₁ can be inserted and fixed in position, by way of example. The spiral spring 106, 106₁ is arranged in an area between the upper part 110, 110₁ and the lower part 111, 111₁ of the wheel 112, 112₁, a distance D4 between the upper part 110, 110₁ and the lower part 111, 111₁ being dimensioned such that the spiral spring 106, 106₁ fits therebetween and also a movement in the second direction 36, 36₁, which is caused by a corresponding movement of the axle 92, 92₁ in the second direction 36, 36₁, is possible.

Moreover, a pusher 113 can be seen in the upper cap magazine 83, the pusher being arranged on the wheel 112 by means of a connecting device 91.

Although the present disclosure has been described with various embodiments, various changes and modifications may be suggested to one skilled in the art. It is intended that the present disclosure encompass such changes and modifications as fall within the scope of the appended claims.

What is claimed is:

1. A cap magazine for providing electrode caps at a pick-up position in an output area for picking up by a welding arm, the cap magazine comprising:
an interior in which electrode caps are arrangeable; and
an axle around which the electrode caps are movable in a direction of rotation around the axle towards the pick-up position,
wherein the electrode caps are adapted to be arranged in the interior and are preloaded in the direction of rotation around the axle towards the pick-up position.

2. The cap magazine of claim 1, wherein the interior is delimited by a base plate, a lid and an at least partially circular-cylindrical jacket of the cap magazine.

3. The cap magazine of claim 2, wherein the axle comprises, at a first end thereof, an adapter device, the first end projecting beyond the interior through the lid.

4. The cap magazine of claim 2, further comprising a housing, which is arranged outside the interior on the lid and through which the axle extends at least partially.

5. The cap magazine of claim 4, wherein, within the housing, the axle is surrounded by a compression spring and the axle comprises a bead, which circumferentially surrounds the axle within the housing and on which a first end turn of the compression spring rests, a second end turn of the compression spring resting on the lid.

6. The cap magazine of claim 3, wherein a second end of the axle, whose cross-section is larger than a cross-section of an axle hole of the axle provided in the base plate, projects beyond the base plate, the base plate having provided thereon a locking plate with an opening, and the second end and the opening being each configured such that the second end is adapted to be accommodated in the opening in form-fit engagement therewith.

7. The cap magazine of claim 6, wherein the second end comprises a pin, which projects beyond the second end and which additionally extends into the axle, or wherein the second end comprises a cavity, which extends from the second end into the axle.

8. The cap magazine of one of the claim 2, wherein a wheel, which is arranged around the axle in the interior, comprises a plurality of recesses along a circumference of the wheel, the recesses having a circular segment-like shape and being additionally configured such that first electrode caps to be provided can be accommodated therein along part of their circumference and arranged on a first radius.

9. The cap magazine of claim 8, wherein a radial distance between the jacket and a center of one of the recesses is configured such that second electrode caps to be provided can be arranged on a second radius, which is larger than the first radius, such that the second electrode caps to be provided contact, at least partially, the jacket and the first electrode caps to be provided.

10. The cap magazine of claim 8, wherein a preloadable spiral spring is arranged around the axle, the spiral spring being configured to rotate the wheel in the direction of rotation about the axle, the electrode caps, which are adapted to be arranged in the interior, being thus preloaded in the direction of rotation around the axle towards the pick-up position.

11. The cap magazine of claim 9, wherein a pushing device is additionally provided, which extends, at least partially, between the wheel and the jacket and which is configured to push, when a rotation in the direction of rotation takes place, the first and second electrode caps to be provided into the direction of rotation.

12. The cap magazine of claim 11, wherein the pushing device comprises a pusher, which has an outer shape corresponding to that of an electrode cap, and a connecting device, the connecting device connecting the pusher with the wheel.

13. The cap magazine of claim 2, wherein the lid comprises an opening in the output area.

14. The cap magazine of claim 1, wherein the output area has provided therein a retainer and a downholder for a respective one of the electrode caps.

15. The cap magazine of one of the claim 1, further comprising a guiding device extending from the interior up to and into the output area.

16. The cap magazine of claim 10, wherein the spiral spring is fastened to the axle and to the wheel.

17. A cap magazine unit comprising:
a first cap magazine and a second cap magazine, wherein an axle of the first cap magazine and an axle of the second cap magazine are oriented coaxially, wherein an outer surface of a first base plate of the first cap magazine faces an outer surface of a second base plate of the second cap magazine, and wherein a distance is defined between the outer surface of the first base plate and the outer surface of the second base plate.

18. The cap magazine unit of claim 17, wherein a spacer plate is provided between the outer surface of the first base plate and the outer surface of the second base plate.

19. The cap magazine unit of claim 17, wherein the axle of the first cap magazine is provided with a cavity, and wherein the axle of the second cap magazine is provided with a pin.

20. The cap magazine unit of claim 19, wherein a compression spring, which partially surrounds the pin, is arranged between a second end of the axle of the first cap magazine and a second end of the axle of the second cap magazine.
